(19) United States
(12) Patent Application Publication
(10) Pub. No.: US 2005/0194893 A1
(43) Pub. Date: Sep. 8, 2005

(54) Display device and method and apparatus of manufacturing the same

(76) Inventors: Dong-Won Lee, Seongnam-si (KR); Joon-Hoo Choi, Seoul (KR); Jin-Koo Chung, Suwon-si (KR)

Correspondence Address: CANTOR COLBURN, LLP, 55 GRIFFIN ROAD SOUTH, BLOOMFIELD, CT, 06002, US

(21) Appl. No.: 11/054,911

(22) Filed: Feb. 9, 2005

(30) Foreign Application Priority Data
Feb. 19, 2004 (KR) 2004-10930

(51) Int. Cl. H05B 33/00; H05B 33/02

(52) U.S. Cl. 313/504; 313/503; 313/506

(57) ABSTRACT

A display device includes a substrate, first and second electrodes, and first, second, third and fourth organic patterns. The substrate includes a first region having first pixel regions, a second region having second pixel regions, and a third region having third pixel regions. The first electrodes are disposed at the first, second and third pixel regions. The first organic patterns are formed at the first pixel regions. The second organic patterns are formed at selected ones of the second pixel regions. The second organic patterns have substantially a same profile as that of the first organic patterns. The third organic patterns are formed at remaining ones of the second pixel regions. The fourth organic patterns are formed at the third pixel regions. The fourth organic patterns have substantially a same profile as that of the third organic patterns. The second electrode covers the first, second, third and fourth organic patterns. Therefore, an image display quality is enhanced.

### BACKGROUND OF THE INVENTION

1. Field of the Invention

The present invention relates to a display device and a method and apparatus for manufacturing the display device. More particularly, the present invention relates to a display device with enhanced display quality and a method and apparatus for manufacturing the display device.

2. Description of the Related Art

A display device converts data processed by an information processing apparatus into images. Various display devices such as a cathode ray tube (CRT) display device, a liquid crystal display (LCD) device, an organic light-emitting device (OLED), a plasma display panel (PDP), etc., have been developed.

The CRT display device displays an image by controlling flows of electrons that collide with a fluorescent layer. The LCD device displays an image by controlling a light transmittance of liquid crystal. The OLED displays an image by controlling current that flows through an organic light-emitting layer. The PDP displays an image using plasma.

The OLED has many merits including thin thickness, high luminance, etc. Furthermore, the OLED has faster response speed, lower power consumption, broader temperature range of operation and lower manufacturing cost than the LCD device. The OLED typically includes anode electrodes, an organic layer, an organic light-emitting layer and a cathode electrode.

The anode electrodes are arranged in a matrix shape on a substrate. The organic layer is formed on the substrate having the anode electrodes formed thereon and has cavities that expose the anode electrodes. The organic light-emitting layer is formed on the anode electrodes exposed through the cavities. The cathode electrode is formed on the organic light-emitting layer.

The organic light-emitting layer includes a hole-injection layer (HIL) and an emitting material layer (EML). The organic light-emitting layer optionally includes an electron-injection layer (EIL).

The organic light-emitting layer may be formed through a slit mask process, a spin coating method, a roll-to-roll process, a vacuum deposition process, an organic material discharging method, etc. Recently, the organic material discharging method has been widely used. In the organic material discharging method, an apparatus for discharging organic material discharges organic material into the cavities in a manner similar to the manner of printing using an ink-jet printer.

A conventional apparatus for discharging organic material scans the cavities one by one in order to discharge the organic material. Discharging the organic material in this manner causes the organic material in each cavity to have different drying times. When the organic material has different drying times between each cavity, the organic light-emitting layer comprises portions having different or non-uniform profiles from one another so that light generated from such portions has non-uniform luminance. As a result image display quality is deteriorated.

### SUMMARY OF THE INVENTION

The present invention provides a display device with enhanced image display quality. The present invention also provides a method suitable for manufacturing the above-mentioned display device. The present invention also provides an apparatus suitable for manufacturing the above-mentioned display device.

In an exemplary display device according to the present invention, the display device includes a substrate, first electrodes, first organic patterns, second organic patterns, third organic patterns, fourth organic patterns and a second electrode. The substrate includes a first region that has a plurality of first pixel regions, a second region adjacent to the first region and has a plurality of second pixel regions, and a third region that is adjacent to the second region and has a plurality of third pixel regions. The first electrodes are disposed at the first, second and third pixel regions. The first organic patterns are formed at the first pixel regions. The second organic patterns are formed at selected ones of the second pixel regions. The second organic patterns have substantially a same profile as that of the first organic patterns. The third organic patterns are formed at remaining ones of the second pixel regions. The fourth organic patterns are formed at the third pixel regions. The fourth organic patterns have substantially a same profile as that of the third organic patterns. The second electrode is disposed at the substrate such that the second electrodes cover the first, second, third and fourth organic patterns.

In another exemplary display device according to the present invention, the display device includes dummy organic patterns contiguous to the first region that have substantially a same profile as the first organic patterns. The display device also includes dummy organic patterns contiguous to the third region that have substantially a same profile as the fourth organic patterns. Additionally, the dummy organic patterns contiguous to the second region each have substantially a same profile as one of the second and third organic patterns.

In an exemplary method of manufacturing a display device according to the invention, a plurality of first electrodes is formed on a substrate including a first region having a plurality of first pixel regions, a second region being adjacent to the first region and having a plurality of second pixel regions, and a third region being adjacent to the second region and having a plurality of third pixel regions, such that the first electrodes correspond to the first, second and third pixel regions. The first organic patterns and second organic patterns are formed at the first pixel regions and selected ones of the second pixel regions, respectively. Third organic patterns and fourth organic patterns are formed at remaining ones of the second pixel regions and the third pixel regions, respectively. Then, a second electrode is disposed at the substrate such that the second electrode covers the first, second, third and fourth organic patterns.

In an exemplary apparatus of manufacturing a display device, the apparatus includes a discharging unit, an organic material providing unit and a transferring unit. The discharging unit includes a first discharging head having a plurality of discharging nozzles, and a second discharging head having a plurality of discharging nozzles. The first discharging head and the second discharging head are substantially parallel to each other. A portion of the first discharging head is adjacent to a portion of the second discharging head. The organic material providing unit provides the discharging unit with organic material. The transferring unit transfers the discharging unit in a first direction.

In another exemplary method of manufacturing a display device according to the invention, a plurality of nozzles are disposed along a length of a first discharging head and a second discharging head such that each nozzle is disposed apart from each adjacent nozzle at a constant interval. The first and second discharging heads are disposed at a transferring unit and transferred in a first direction with respect to a substrate. First organic patterns are formed at a first region of the substrate and second organic patterns are formed at selected portions of a second region of the substrate using the first discharging head. Third organic patterns are formed at remaining portions of the second region and fourth organic patterns are formed at a third region of the substrate using a second discharging head.

According to the present invention, boundary defects caused by differences in drying time of the organic material may be attenuated or diluted to enhance an image display quality of a display device.

The present application claims priority from Korean Patent Application No. 2004-10930, filed on Feb. 19, 2004, the disclosure of which is hereby incorporated herein by reference in its entirety.

### BRIEF DESCRIPTION OF THE DRAWINGS

The above and other features and advantages of the present invention will become more apparent by describing detailed exemplary embodiments thereof with reference to the accompanying drawings, in which:

FIG. 1 is a plan view illustrating a display device according to an exemplary embodiment of the present invention;

FIG. 2 is a cross-sectional view of the display device taken along line I-I′ in FIG. 1;

FIG. 3 is a plan view illustrating the display device of FIG. 1 having organic patterns formed on the substrate;

FIG. 4 is a plan view illustrating the display device of FIG. 1 having an alternative arrangement of organic patterns formed on the substrate;

FIG. 5 is a plan view illustrating the display device of FIG. 1 having another alternative arrangement of organic patterns formed on the substrate;

FIG. 6 is a plan view illustrating a display device according to another exemplary embodiment of the present invention;

FIG. 7 is a cross-sectional view of the display device taken along line II-II′ in FIG. 6;

FIG. 8 is a plan view illustrating the display device of FIG. 6 having first and second organic patterns formed on the substrate;

FIG. 9 is a plan view illustrating the display device of FIG. 8 having third and fourth organic patterns formed on the substrate;

FIG. 10 is a plan view illustrating the display device of FIG. 6 having an alternative arrangement of the first and second organic patterns formed on the substrate;

FIG. 11 is a plan view illustrating the display device of FIG. 10 having an alternative arrangement of the third and fourth organic patterns formed on the substrate;

FIG. 12 is a plan view illustrating the display device of FIG. 6 having another alternative arrangement of the first and second organic patterns formed on the substrate;

FIG. 13 is a plan view illustrating the display device of FIG. 12 having another alternative arrangement of the third and fourth organic patterns formed on the substrate; and

FIG. 14 is a schematic view illustrating an apparatus for manufacturing a display device.

### DESCRIPTION OF EMBODIMENTS

It should be understood that the exemplary embodiments of the present invention described below may be modified in many different ways without departing from the inventive principles disclosed herein, and the scope of the present invention is therefore not limited to these particular flowing embodiments. Rather, these embodiments are provided so that this disclosure will be thorough and complete, and will fully convey the concept of the invention to those skilled in the art by way of example and not of limitation.

Hereinafter, the embodiments of the present invention will be described in detail with reference to the accompanied drawings.

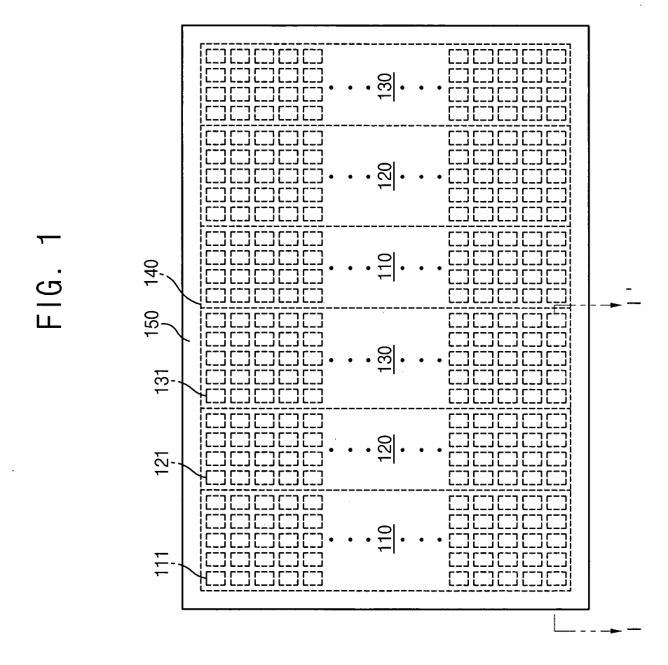

FIG. 1 is a plan view illustrating a display device according to an exemplary embodiment of the present invention. In this exemplary embodiment, an organic light-emitting device (OLED) will be described as the display device.

Referring to FIG. 1, the display device of this embodiment includes a main region 140 (or display region) and a sub region 150 (or non-display region) that are configured on a substrate. The main region 140 includes a first region 110, a second region 120, and a third region 130. The sub region 150 surrounds the main region 140. The first, second and third regions 110, 120 and 130 are formed on a same face of the substrate 100. In this exemplary embodiment, the main region 140 includes multiple first regions 110, multiple second regions 120, and multiple third regions 130. A first set of first, second and third regions 110, 120 and 130 are adjacently disposed in numerical order followed by a second set of first, second and third regions 110, 120 and 130 also adjacently disposed in numerical order. Additional sets of first, second and third regions 110, 120 and 130 are also possible. Within the first set of first, second and third regions 110, 120 and 130, for example, the first region 110 is adjacent to the second region 120 and the second region 120 is disposed between the first and third regions 110 and 130. The first region 110 of the second set of first, second and third regions 110, 120 and 130 is disposed between the third region 130 of the first set of first, second and third regions 110, 120 and 130 and the second region 120 of the second set of first, second and third regions 110, 120 and 130, etc.

Each of the first, second and third regions 110, 120 and 130 includes pixel regions for displaying an image. For example, the first region 110 includes first pixel regions 111, the second region 120 includes second pixel regions 121, and the third region 130 includes third pixel regions 131. The first pixel regions 111 are arranged in a matrix shape in the first region 110. The second pixel regions 121 are also arranged in a matrix shape in the second region 120. The third pixel regions 131 are also arranged in a matrix shape in the third region 130. A matrix shape includes pixel regions arranged in columns aligned vertically in a first direction (referred to below as a column direction), and pixel regions arranged in rows aligned horizontally in a second direction (referred to below as a row direction) that is substantially perpendicular to the first direction.

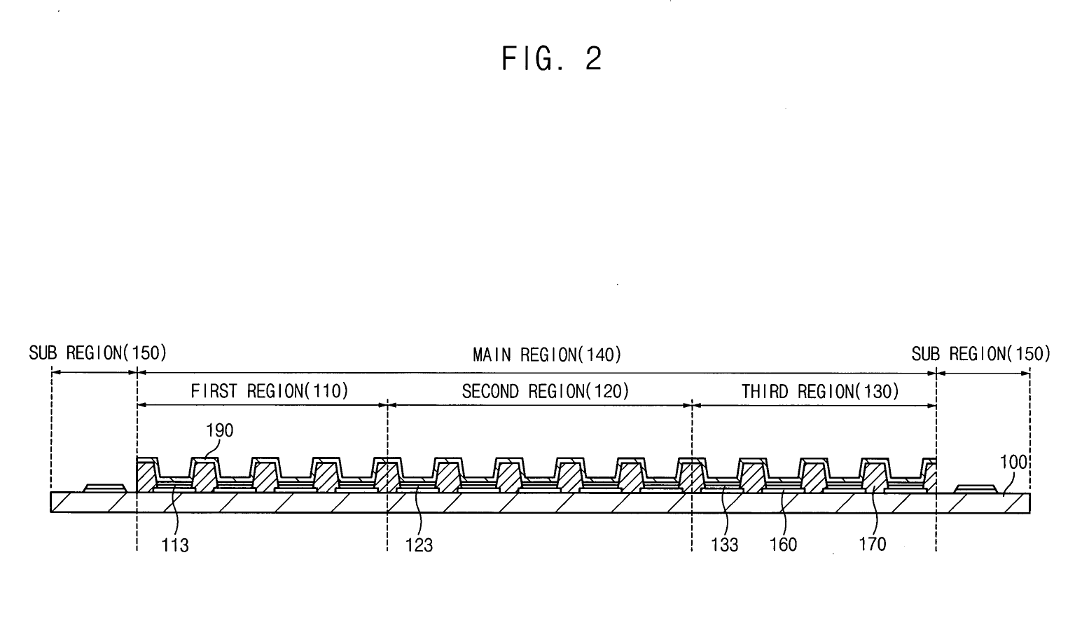

FIG. 2 is a cross-sectional view of the display device taken along line I-I′ in FIG. 1.

Referring to FIGS. 1 and 2, first electrodes 160 are formed on the substrate 100 of the display device in a matrix shape such that the first electrodes 160 each correspond to each of the first pixel regions 111 of the first region 110, the second pixel regions 121 of the second region 120 and the third pixel regions 131 of the third region 130. The first electrodes 160 include optically transparent and electrically conductive material such as indium tin oxide (ITO), indium zinc oxide (IZO), etc.

A partition member 170 is formed on the substrate 100. The partition member 170 includes cavities that expose the first electrodes 160. The partition member 170 may include an organic material such as a photosensitive material or inorganic material. The partition member 170 electrically and physically separates each one of the pixel regions from each other.

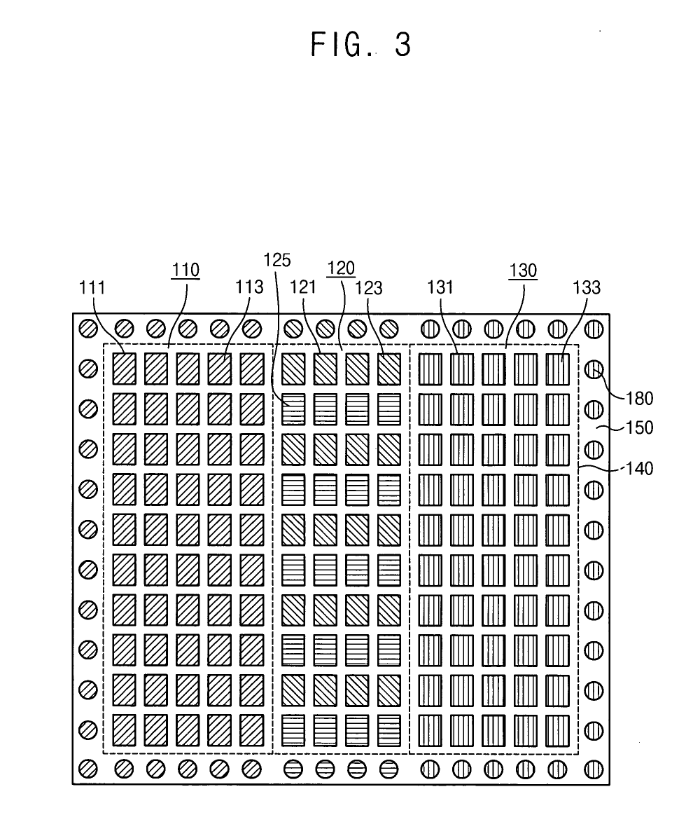

FIG. 3 is a plan view illustrating the display device of FIG. 1 having organic patterns formed on the substrate.

Referring to FIGS. 1, 2 and 3, organic patterns that have a double-layered structure are formed in the first, second and third pixel regions 111, 121 and 131 of the substrate 100. For example, the organic patterns include a hole-injection layer and an emitting material layer. The first region 110 includes first organic patterns 113 corresponding to the first pixel regions 111. The second region 120 includes second and third organic patterns 123 and 125 corresponding to the second pixel regions 121. The third region 130 includes fourth organic patterns 133 corresponding to the third pixel regions 131. The first, second, third and fourth organic patterns 113, 123, 125 and 133 include same material.

The second organic patterns 123 are disposed on odd-numbered rows of the second pixel regions 121 in the second region 120, and the third organic patterns 125 are disposed on even-numbered rows of the second pixel regions 121 in the second region 120. Therefore, rows having the second organic patterns 123 and rows having the third organic patterns 125 alternate with each other.

The first organic patterns 113 are disposed in the first region 110 and the second organic patterns 123 are disposed in the second region 120 as a single step of a scanning procedure, which applies the organic patterns in the first, second and third pixel regions 111, 121 and 131 of the substrate 100. Therefore, the first organic patterns 113 of the first region 110 and the second organic patterns 123 of the second region 120 have substantially a same profile. The third organic patterns 125 are disposed in the second region 120 and the fourth organic patterns 133 are disposed in the third region 130 as a single step of the scanning procedure. Therefore, the third organic patterns 125 of the second region 120 and the fourth organic patterns 133 of the third region 130 have substantially a same profile.

Alternatively, the first organic patterns 113 of the first region 110 and the third organic patterns 125 of the second region 120 may be formed as a single step of the scanning procedure, and the second organic patterns 123 of the second region 120 and the fourth organic patterns 133 of the third region 130 may be formed as a single step of the scanning procedure. Therefore, the first organic patterns 113 of the first region 110 and the third organic patterns 125 of the second region 120 have substantially a same profile, and the second organic patterns 123 of the second region 120 and the fourth organic patterns 133 of the third region 130 have substantially a same profile.

When an organic material is provided to dispose organic patterns at a portion of the second region 120 and the first region 110 during a single step of the scanning procedure, and the organic material is provided to dispose organic patterns at a remaining portion of the second region 120 and the third region 130 during another single step of the scanning procedure, boundary defects caused by a difference in drying times of the organic material may be attenuated or diluted.

The drying times of organic material in the pixel regions 111, 121 and 131 depend on boundary conditions of the pixel regions. For example, the organic material of pixel regions near a boundary of the main region 140 is dried faster than the organic material of pixel regions near interior portions of the main region 140. Therefore, to uniformize drying times of the organic material near interior portions of the main region 140 with drying times of organic material near the boundary of the main region 140, dummy organic patterns 180 are formed in the sub region 150 that surrounds the main region 140. Dummy organic patterns 180 cause conditions of the pixel regions disposed near the boundary of the main region 140 to become substantially similar to conditions of the pixel regions disposed near interior portions of the main region 140, so that drying times are uniformized.

A second electrode 190 is formed on the substrate 100 having the first, second, third and fourth organic patterns 113, 123, 125 and 133 formed thereon. The second electrode 190 may be formed such that the second electrode 190 covers the first, second, third and fourth organic patterns 113, 123, 125 and 133 and the partition member 170. The second electrode 190 includes, for example, aluminum (Al) or aluminum alloy.

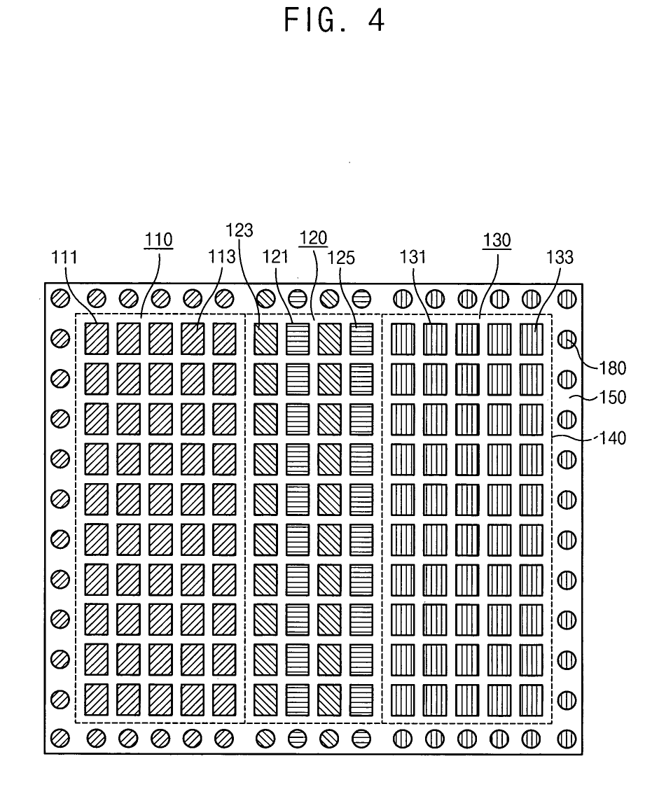

FIG. 4 is a plan view illustrating another embodiment of the display device having an alternative arrangement of organic patterns formed on the substrate. The display device of the present embodiment is the same as one in FIG. 3 except for an arrangement of the second and third organic patterns. Thus, the same reference numerals will be used to refer to the same or like parts as those described in FIG. 3 and any further explanation will be omitted.

Referring to FIG. 4, the second region 120 includes the second and third organic patterns 123 and 125 disposed at corresponding portions of the second pixel regions 121. The second organic patterns 123 are disposed on odd-numbered columns of second pixel regions 121 in the second region 120, and the third organic patterns 125 are disposed on even-numbered columns of second pixel regions 121 in the second region 120. Therefore, columns having the second organic patterns 123 and columns having the third organic patterns 125 alternate with each other.

The first organic patterns 113 of the first region 110 and the second organic patterns 123 of the second region 120 are formed during a single step of the scanning procedure, and the third organic patterns 125 of the second region 120 and the fourth organic patterns 133 of the third region 130 are formed during another single step of the scanning procedure. In this case, the first organic patterns 113 of the first region 110 and the second organic patterns 123 of the second region 120 have substantially a same profile, and the third organic patterns 125 of the second region 120 and the fourth organic patterns 133 of the third region 130 have substantially a same profile.

Alternatively, the first organic patterns 113 of the first region 110 and the third organic patterns 125 of the second region 120 are formed during a single step of the scanning procedure, and the second organic patterns 123 of the second region 120 and the fourth organic patterns 133 of the third region 130 are formed during another single step of the scanning procedure. In this case, the first organic patterns 113 of the first region 110 and the third organic patterns 125 of the second region 120 have substantially a same profile, and the second organic patterns 123 of the second region 120 and the fourth organic patterns 133 of the third region 130 have substantially a same profile.

When organic material is provided to dispose organic patterns at a portion of the second region 120 and the first region 110 during a single step of the scanning procedure, and the organic material is provided to dispose organic patterns at a remaining portion of the second region 120 and the third region 130 during another single step of the scanning procedure, boundary defects caused by a difference in drying times of the organic material may be attenuated or diluted.

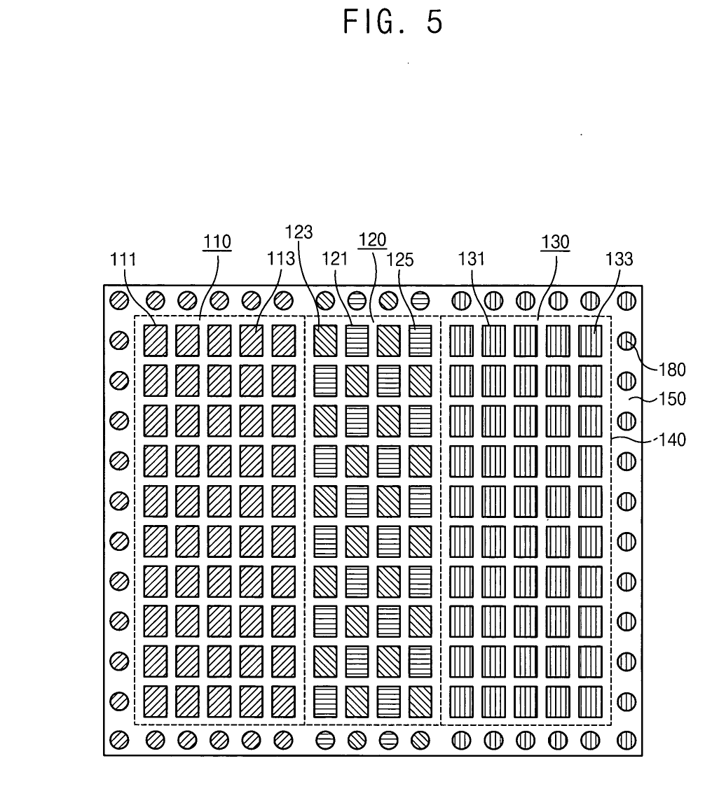

FIG. 5 is a plan view illustrating another embodiment of the display device having another alternative arrangement of organic patterns formed on the substrate. The display device of the present embodiment is the same as one in FIG. 3 except for an arrangement of the second and third organic patterns. Thus, the same reference numerals will be used to refer to the same or like parts as those described in FIG. 3 and any further explanation will be omitted.

Referring to FIG. 5, the second region 120 includes the second and third organic patterns 123 and 125 disposed at corresponding portions of the second pixel regions 121. In this embodiment, the second organic patterns 123 and the third organic patterns 125 are disposed alternately throughout the second pixel regions 121. In other words, the four sides of the respective second pixel regions 121 having the second organic patterns 123 are surrounded by second pixel regions 121 having the third organic patterns 125, and the four sides of the respective second pixel regions 121 having the third organic patterns 125 are surrounded by second pixel regions 121 having the second organic patterns 123.

First organic patterns 113 of the first region 110 and the second organic patterns 123 of the second region 120 are formed during a single step of the scanning procedure, and the third organic patterns 125 of the second region 120 and fourth organic patterns 133 of third region 130 are formed during another single step of the scanning procedure. Therefore, the first organic patterns 113 of the first region 110 and the second organic patterns 123 of the second region 120 have substantially a same profile, and the third organic patterns 125 of the second region 120 and the fourth organic patterns 133 of the third region 130 have substantially a same profile.

Alternatively, the first organic patterns 113 of the first region 110 and the third organic patterns 125 of the second region 120 are formed during a single step of the scanning procedure, and the second organic patterns 123 of the second region 120 and the fourth organic patterns 133 of the third region 130 are formed during another single step of the scanning procedure. In this case, the first organic patterns 113 of the first region 110 and the third organic patterns 125 of the second region 120 have substantially a same profile, and the second organic patterns 123 of the second region 120 and the fourth organic patterns 133 of the third region 130 have substantially a same profile.

When organic material is provided to dispose organic patterns at a portion of the second region 120 and the first region 110 during a single step of the scanning procedure, and the organic material is provided to dispose organic patterns at a remaining portion of the second region 120 and the third region 130 during another single step of the scanning procedure, boundary defects caused by a difference in drying times of the organic material may be attenuated or diluted.

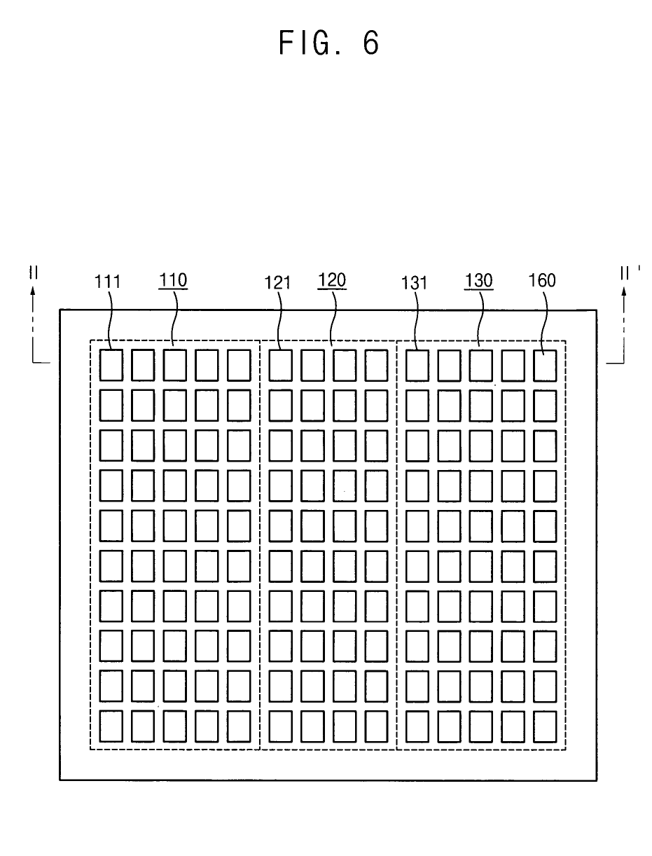

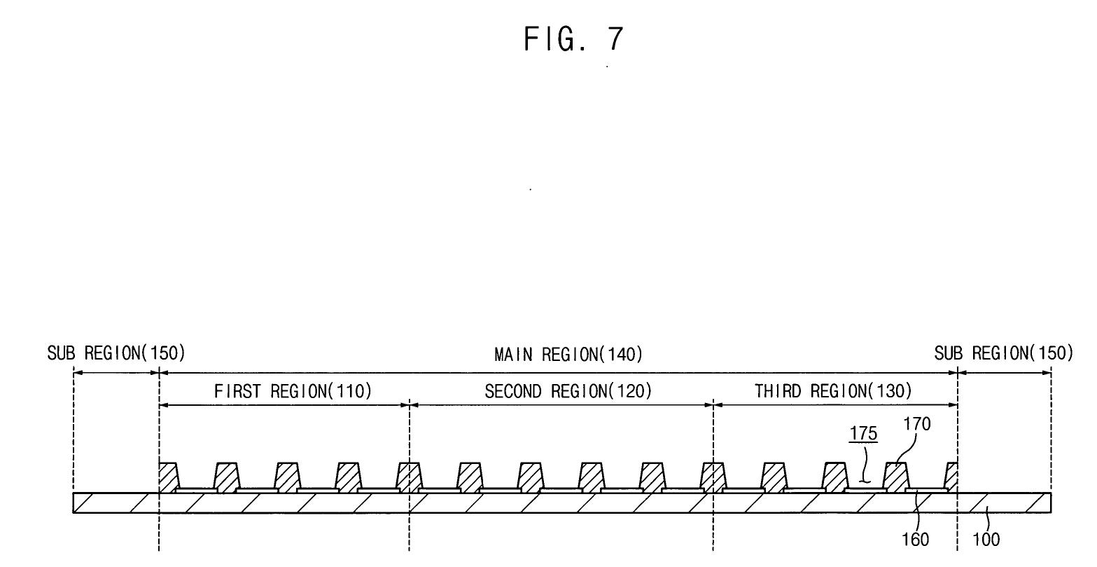

FIG. 6 is a plan view illustrating a display device according to another exemplary embodiment of the present invention, and FIG. 7 is a cross-sectional view of the display device taken along line II-II′ in FIG. 6.

Referring to FIGS. 6 and 7, a transparent and conductive layer is formed on the substrate 100 including the first region 110, the second region 120 and the third region 130 defined thereon. The second region 120 is disposed between the first and third regions 110 and 130. The transparent and conductive layer is patterned to form the first electrodes 160 that are arranged in a matrix shape in the first, second and third regions 110, 120, and 130. Regions of the first region 110, where the first electrodes 160 are formed, are defined as the first pixel regions 111. Regions of the second region 120, where the first electrodes 160 are formed, are defined as the second pixel regions 121. Regions of the third region 130, where the first electrodes 160 are formed, are defined as the third pixel regions 131.

In association with the first electrodes 160 on the substrate 100, driver circuits (not shown) for driving the first electrodes 160 are formed. Each driver circuit driving one of the first electrodes 160 includes, for example, two thin film transistors, one capacitor and signal lines.

An organic layer is formed on the substrate 100 having the first electrodes 160 formed thereon. The organic layer may include photosensitive material.

The organic layer is patterned to expose the first electrodes 160, so that the partition member 170 is formed. Hereinafter, spaces defined by the partition member 170 and formed over the first electrodes 160 are referred to as cavities 175.

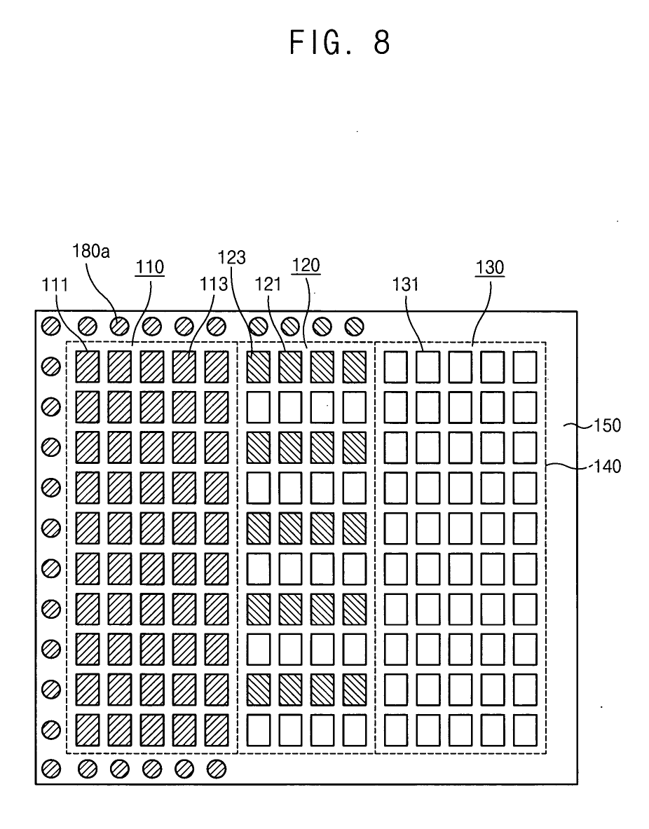

FIG. 8 is a plan view illustrating the display device of FIG. 6 having first and second organic patterns 113 and 123 formed on the substrate 100.

Referring to FIGS. 7 and 8, first and second organic patterns 113 and 123 are formed on the substrate 100 having the first electrodes 160 formed thereon. The first organic patterns 113 are formed in the first pixel regions 111 arranged in a matrix shape. The second organic patterns 123 are formed in odd numbered rows of the second pixel regions 121 arranged in a matrix shape.

The first and second organic patterns 113 and 123 are formed by discharging droplets of organic material onto the above specified first electrodes 160 to create the first and second organic patterns 113 and 123. Droplets of organic material are discharged onto the first electrodes 160 corresponding to all rows of the first pixel regions 111 and odd numbered rows of the second pixel regions 121 along the column direction of the first and second pixel regions 111 and 121. Additionally, dummy organic patterns 180a are formed in the sub region 150 that surrounds the main region 140 including the first, second and third regions 110, 120 and 130. The dummy organic patterns 180a uniformize drying times of the organic material near interior portions of the main region 140 with drying times of organic material near the boundary of the main region 140.

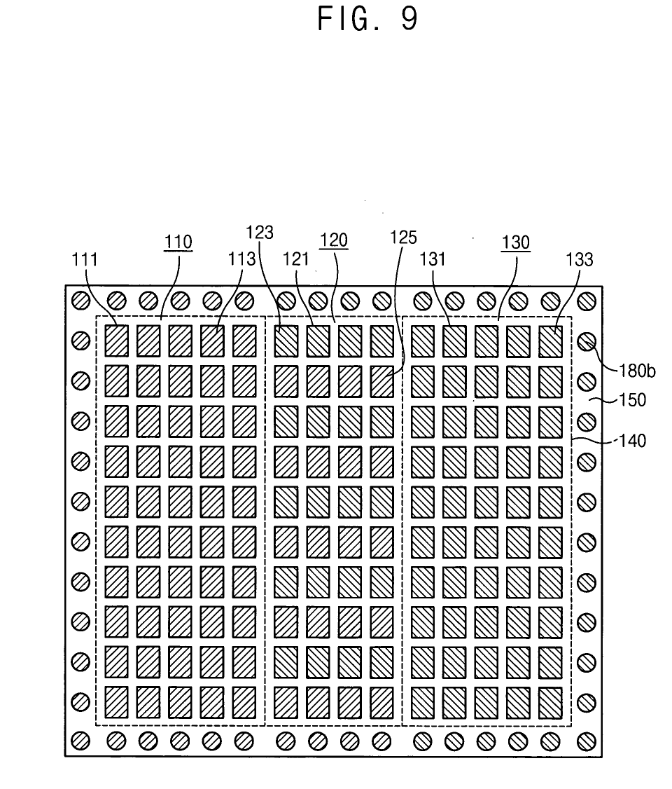

FIG. 9 is a plan view illustrating the display device of FIG. 8 having third and fourth organic patterns 125 and 133 formed on the substrate.

Referring to FIG. 9, the third and fourth organic patterns 125 and 133 are formed on the substrate having the first and second organic patterns 113 and 123 formed thereon. The third organic patterns 125 are formed in even numbered rows of the second pixel regions 121 arranged in a matrix shape. The fourth organic patterns 133 are formed in the third pixel regions 131 arranged in a matrix shape.

The third and fourth organic patterns 125 and 133 are formed by discharging droplets of organic material onto the above specified first electrodes 160 to create the third and fourth organic patterns 125 and 133. Droplets of organic material are discharged onto the first electrodes 160 corresponding to all rows of the third pixel regions 131 and even numbered rows of the second pixel regions 121 along the column direction of the second and third pixel regions 121 and 131. Additionally, dummy organic patterns 180b are formed in the sub region 150 that surrounds the main region 140 including the first, second and third regions 110, 120 and 130. The dummy organic patterns 180b uniformize drying times of the organic material near interior portions of the main region 140 with drying times of organic material near the boundary of the main region 140.

The first, second, third and fourth organic patterns 113, 123, 125 and 133 have double-layered structure of a hole-injection layer and an emitting material layer. The above-described process is performed twice in order to complete the first, second, third and fourth organic patterns 113, 123, 125 and 133. In other words, the hole-injection layer is discharged onto the first electrodes 160 of the first, second and third pixel regions 111, 121 and 131 as described above referring to FIGS. 8 and 9, and then the emitting material layer is discharged onto the first electrodes 160 of the first, second and third pixel regions 111, 121 and 131 as described above referring to FIGS. 8 and 9.

Finally, second electrodes are formed on the substrate 100 such that the second electrodes cover the first, second, third and fourth organic patterns 113, 123, 125 and 133. The second electrodes include, for example, aluminum or aluminum alloy.

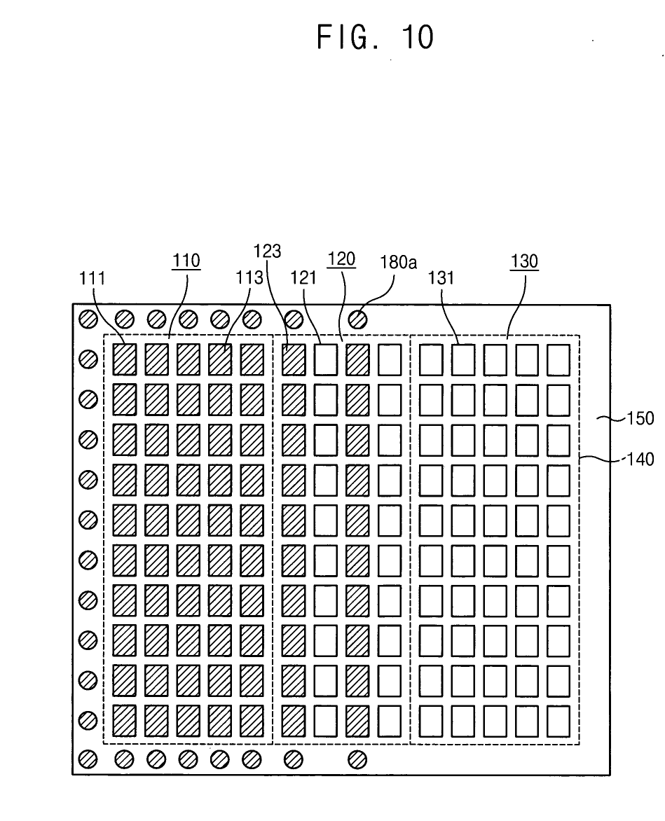

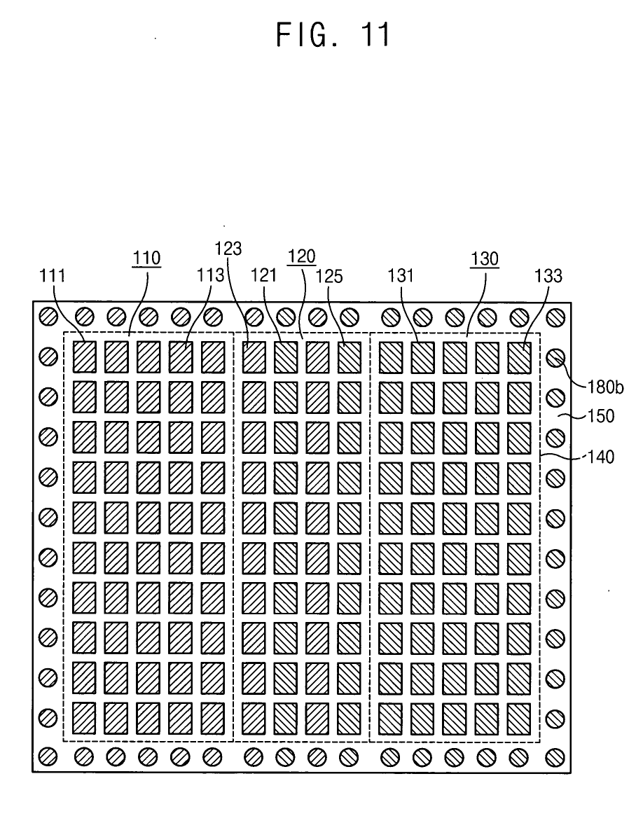

FIG. 10 is a plan view illustrating the display device of FIG. 6 having an alternative arrangement of the first and second organic patterns 113 and 123 formed on the substrate. FIG. 11 is a plan view illustrating the display device of FIG. 10 having an alternative arrangement of the third and fourth organic patterns 125 and 133 formed on the substrate. The method of manufacturing a display device of the present embodiment is same as the method described above referring to FIGS. 8 and 9 except for forming of the first, second, third, and fourth organic patterns 113, 123, 125, and 133. Thus, the same reference numerals will be used to refer to the same or like parts as those described in FIGS. 8 and 9 and any further explanation will be omitted.

Referring to FIG. 10, first and second organic patterns 113 and 123 are formed on the substrate having the first electrodes 160 formed thereon. The first organic patterns 113 are formed in first pixel regions 111 arranged in a matrix shape. The second organic patterns 123 are formed in odd numbered columns of second pixel regions 121 arranged in a matrix shape.

The first and second organic patterns 113 and 123 are formed by discharging droplets of organic material onto the above specified first electrodes 160 to create the first and second organic patterns 113 and 123. Droplets of organic material are discharged onto the first electrodes 160 corresponding to all columns of the first pixel regions 111 and odd numbered columns of the second pixel regions 121 along the column direction of the first and second pixel regions 111 and 121. Additionally, dummy organic patterns 180a are formed in the sub region 150 that surrounds the main region 140 including first, second and third regions 110, 120 and 130. The dummy organic patterns 180a uniformize drying times of the organic material near interior portions of the main region 140 with drying times of organic material near the boundary of the main region 140.

Referring to FIG. 11, third and fourth organic patterns 125 and 133 are formed on the substrate having the first and second organic patterns 113 and 123 formed thereon. The third organic patterns 125 are formed in even numbered columns of the second pixel regions 121 arranged in a matrix shape. The fourth organic patterns 133 are formed in third pixel regions 131 arranged in a matrix shape.

The third and fourth organic patterns 125 and 133 are formed by discharging droplets of organic material onto the above specified first electrodes 160 to create the third and fourth organic patterns 125 and 133. Droplets of organic material are discharged onto the first electrodes 160 corresponding to all columns of the third pixel regions 131 and even numbered columns of the second pixel regions 121 along the column direction of the second and third pixel regions 121 and 131. Additionally, dummy organic patterns 180b are formed in the sub region 150 that surrounds the main region 140 including the first, second and third regions 110, 120 and 130. The dummy organic patterns 180b uniformize drying times of the organic material near interior portions of the main region 140 with drying times of organic material near the boundary of the main region 140.

The first, second, third and fourth organic patterns 113, 123, 125 and 133 have two-layered structure of the hole-injection layer and the emitting material layer. The above-described process is performed twice in order to complete the first, second, third and fourth organic patterns 113, 123, 125 and 133. In other words, the hole-injection layer is discharged onto the first electrodes 160 of the first, second and third pixel regions 111, 121 and 131 as described above referring to FIGS. 10 and 11, and then the emitting material layer is discharged onto the first electrodes 160 of the first, second and third pixel regions 111, 121 and 131 as described above referring to FIGS. 10 and 11.

Finally, second electrodes are formed on the substrate such that the second electrodes cover first, second, third and fourth organic patterns 113, 123, 125 and 133. The second electrodes include, for example, aluminum or aluminum alloy.

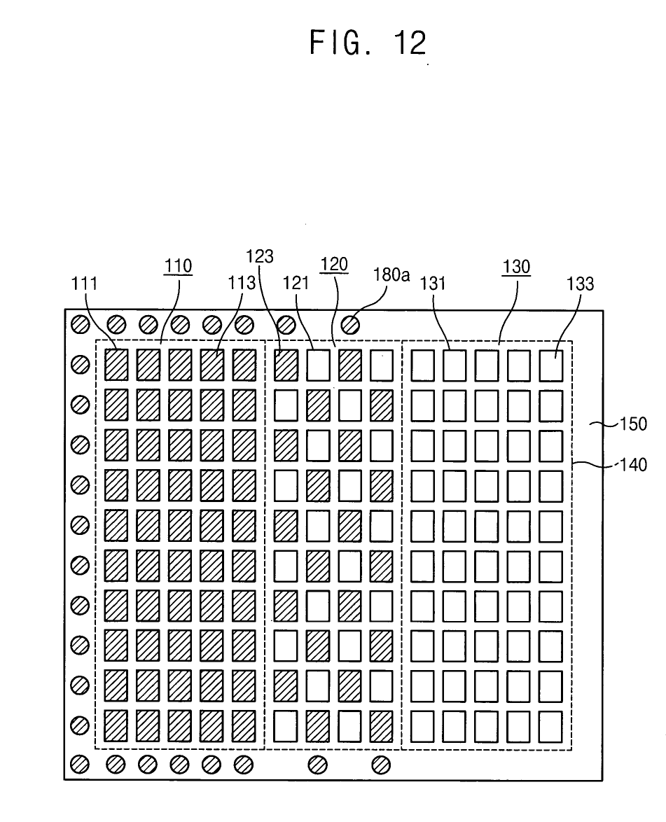

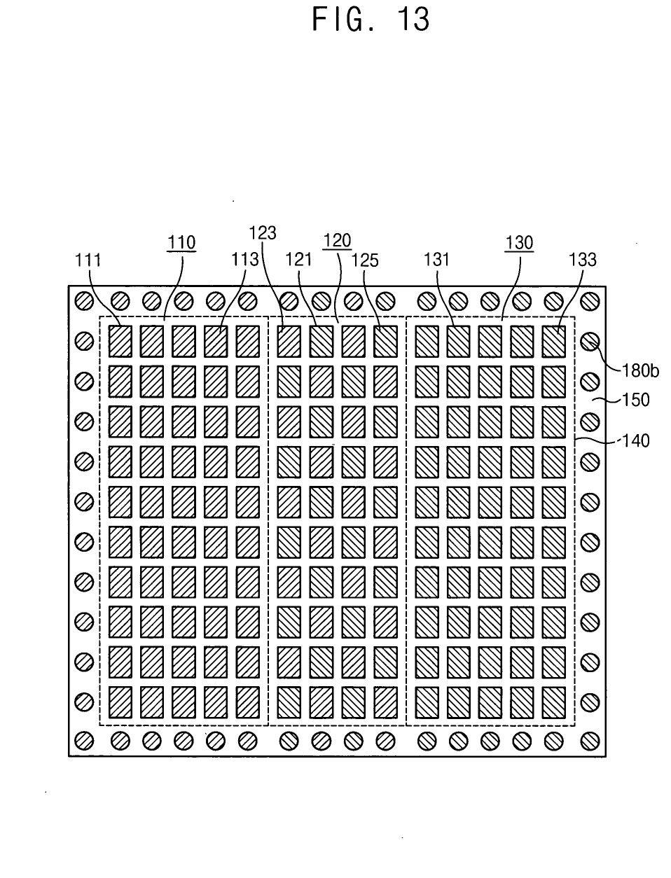

FIG. 12 is a plan view illustrating the display device of FIG. 6 having another alternative arrangement of the first and second organic patterns 113 and 123 formed on the substrate. FIG. 13 is a plan view illustrating the display device of FIG. 12 having another alternative arrangement of the third and fourth organic patterns 125 and 133 formed on the substrate. The method of manufacturing the display device of the present embodiment is same as the method described above referring to FIGS. 8 and 9 except for forming of the first, second, third, and fourth organic patterns 113, 123, 125 and 133. Thus, the same reference numerals will be used to refer to the same or like parts as those described in FIGS. 8 and 9 and any further explanation will be omitted.

Referring to FIG. 12, first and second organic patterns 113 and 123 are formed on the substrate having the first electrodes 160 formed thereon. The first organic patterns 113 are formed in first pixel regions 111 arranged in a matrix shape. The second organic patterns 123 are formed on portions of first electrodes 160 of the second region 120 such that each second organic pattern 123 alternates with bare first electrodes 160 in second pixel regions 121 arranged in a matrix shape along both row and column directions of the second pixel regions 121.

The first and second organic patterns 113 and 123 are formed by discharging droplets of organic material onto the above specified first electrodes 160 to create the first and second organic patterns 113 and 123. Droplets of organic material are discharged onto the first electrodes 160 corresponding to all of the first pixel regions 111 and portions of the second pixel regions 121 along the column direction of the first and second pixel regions 111 and 121. Additionally, dummy organic patterns 180a are formed in the sub region 150 that surrounds the main region 140 including first, second and third regions 110, 120 and 130. The dummy organic patterns 180a uniformize drying times of the organic material near interior portions of the main region 140 with drying times of organic material near the boundary of the main region 140.

Referring to FIG. 13, third and fourth organic patterns 125 and 133 are formed on the substrate having the first and second organic patterns 113 and 123 formed thereon. The third organic patterns 125 are formed on remaining portions of the first electrodes 160 of the second region 120 such that each third organic pattern 125 alternates with each of the second organic patterns 123 in the second pixel regions 121 arranged in a matrix shape along the row and column directions of the second pixel regions 121. The fourth organic patterns 133 are formed in third pixel regions 131 arranged in a matrix shape.

The third and fourth organic patterns 125 and 133 are formed by discharging droplets of organic material onto the above specified first electrodes 160 to create the third and fourth organic patterns 125 and 133. Droplets of organic material are discharged onto the first electrodes 160 corresponding to all of the third pixel regions 131 and the portions of the second pixel regions 121 along the column direction of the second and third pixel regions 121 and 131. Additionally, dummy organic patterns 180b are formed in the sub region 150 that surrounds the main region 140 including the first, second and third regions 110, 120 and 130. The dummy organic patterns 180b uniformize drying times of the organic material near interior portions of the main region 140 with drying times of organic material near the boundary of the main region 140.

The first, second, third and fourth organic patterns 113, 123, 125 and 133 have two-layered structure of the hole-injection layer and the emitting material layer. The above-described process is performed two times in order to complete the organic patterns 113, 123, 125 and 133. In other words, the hole-injection layer is discharged onto the first electrodes 160 of the first, second and third pixel regions 111, 121 and 131 as described above referring to FIGS. 12 and 13, and then the emitting material layer is discharged onto the first electrodes 160 of the first, second and third pixel regions 111, 121 and 131 as described above referring to FIGS. 12 and 13.

Finally, the second electrodes are formed on the substrate such that the second electrodes cover first, second, third and fourth organic patterns 113, 123, 125 and 133. The second electrodes include, for example, aluminum or aluminum alloy.

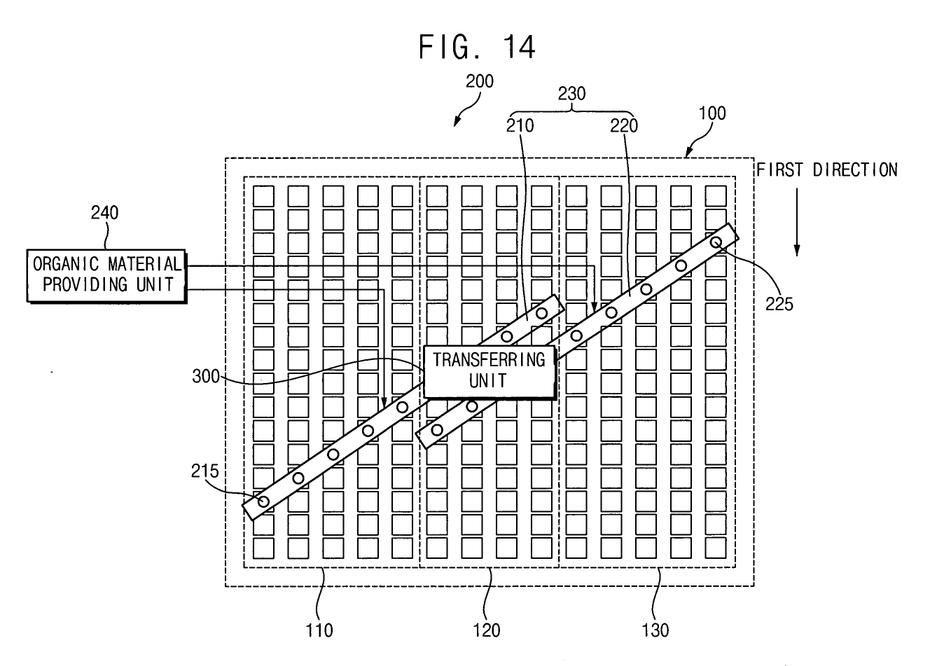

FIG. 14 is a schematic view illustrating an apparatus for manufacturing the display device. The manufacturing apparatus may be employed in order to manufacture an OLED, an LCD device, a PDP, etc.

Referring to FIG. 14, the manufacturing apparatus 200 includes a discharging unit 230, an organic material providing unit 240 and a transferring unit 300. The discharging unit 230 includes, for example, a first discharging head 210 and a second discharging head 220.

The first discharging head 210 includes a plurality of nozzles 215. The plurality of nozzles 215 of the first discharging head 210 are arranged such that each nozzle 215 is disposed at an interval from each other nozzle 215 along a longitudinal direction of the first discharging head 210. The first discharging head 210 is transferred along the first direction (the column direction). The first discharging head 210 is disposed such that the first discharging head 210 is slanted with respect to the first direction and substantially parallel to the substrate 100 as the first discharging head 210 is transferred along the first direction. The first discharging head 210 is disposed such that the first discharging head 210 extends over the first and second regions 110 and 120.

The second discharging head 220 includes a plurality of nozzles 225. The plurality of nozzles 225 of the second discharging head 220 are arranged such that each nozzle 225 is disposed at an interval from each other nozzle 225 along a longitudinal direction of the second discharging head 220. The second discharging head 220 is transferred along the first direction. The second discharging head 220 is disposed such that the second discharging head 220 is slanted with respect to the first direction and substantially parallel to the substrate 100 as the second discharging head 220 is transferred along the first direction. The second discharging head 220 is also substantially parallel to the first discharging head 210. The second discharging head 220 is disposed such that the second discharging head 220 extends over the second and third regions 120 and 130. The first and second discharging heads 210 and 220 are disposed such that a portion of the first discharging head 210 extended over the second region 120 are adjacent to a portion of the second discharging head 220 extended over the second region 120.

The organic material providing unit 240 provides the first and second discharging heads 210 and 220 with organic material for the hole-injection layer or the emitting material layer.

The transferring unit 300 transfers the first and second discharging heads 210 and 220 along the first direction. The transferring unit 300 includes, for example, an XY-table (not shown) for transferring the first and second discharging heads 210 and 220 along the first direction and the second direction that is substantially perpendicular to the first direction. Alternatively, the transferring unit 300 transfers the substrate 100.

According to the present invention, the boundary defects caused by differences in drying time of the organic material may be attenuated or diluted to enhance the image display quality of the display device.

Having described the exemplary embodiments of the present invention and its advantages, it is noted that various changes, substitutions and alterations can be made herein without departing from the spirit and scope of the invention as defined by appended claims.

1. A display device comprising:
a substrate including a first region having a plurality of first pixel regions, a second region adjacent to the first region and having a plurality of second pixel regions, and a third region adjacent to the second region and having a plurality of third pixel regions;
first electrodes disposed at the first, second and third pixel regions;
first organic patterns formed at the first pixel regions;
second organic patterns formed at selected ones of the second pixel regions, the second organic patterns having substantially a same profile as the first organic patterns;
third organic patterns formed at remaining ones of the second pixel regions;
fourth organic patterns formed at the third pixel regions, the fourth organic patterns having substantially a same profile as that of the third organic patterns; and
a second electrode disposed at the substrate such that the second electrode cover the first, second, third and fourth organic patterns.

2. The display device of claim 1, wherein the first, second and third pixel regions are arranged in a matrix shape in the first, second and third regions, respectively.

3. The display device of claim 2, wherein the second organic patterns are formed at odd numbered rows of the second pixel regions, and the third organic patterns are formed at even numbered rows of the second pixel regions.

4. The display device of claim 2, wherein the second organic patterns are formed at odd numbered columns of the second pixel regions, and the third organic patterns are formed at even numbered columns of the second pixel regions.

5. The display device of claim 2, wherein the second and third organic patterns are formed such that each of the second organic patterns alternates with each of the third organic patterns along the row and column directions of the second pixel regions.

6. The display device of claim 1, wherein the first, second and third regions are formed repeatedly such that a first set of the first, second and third regions are adjacently disposed in numerical order followed by a second set of the first, second and third regions also adjacently disposed in numerical order, wherein the third region of the first set is disposed adjacent to the first region of the second set.

7. The display device of claim 1, wherein the substrate comprises a non-display region that surrounds a display region including the first, second and third regions.

8. The display device of claim 7, further comprising dummy organic patterns formed in the non-display region.

9. The display device of claim 8, wherein the dummy organic patterns contiguous to the first region have substantially a same profile as the first organic patterns, and the dummy organic patterns contiguous to the third region have substantially a same profile as the fourth organic patterns.

10. The display device of claim 9, wherein the dummy organic patterns contiguous to the second region each have substantially a same profile as one of the second and third organic patterns.

11. The display device of claim 1, wherein the first, second, third and fourth organic patterns comprise a hole-injection layer and an emitting material layer.

12. The display device of claim 1, wherein the first electrodes comprise a transparent conductive material, and the second electrode comprises a metal.

13. A method of manufacturing a display device, comprising:
forming a plurality of first electrodes on a substrate including a first region having a plurality of first pixel regions, a second region being adjacent to the first region and having a plurality of second pixel regions, and a third region being adjacent to the second region and having a plurality of third pixel regions, wherein the first electrodes correspond to the first, second and third pixel regions;
forming first organic patterns and second organic patterns at the first pixel regions and selected ones of the second pixel regions, respectively;
forming third organic patterns and fourth organic patterns at remaining ones of the second pixel regions and the third pixel regions, respectively; and
forming a second electrode on the substrate such that the second electrode covers the first, second, third and fourth organic patterns.

14. The method of claim 13, further including arranging the first, second and third pixel regions in a matrix shape in the first, second and third regions, respectively.

15. The method of claim 14, wherein forming the second and third organic patterns comprises:
disposing the second organic patterns at odd numbered rows of the second pixel regions; and
disposing the third organic patterns at even numbered rows of the second pixel regions.

16. The method of claim 14, wherein forming the second and third organic patterns comprises:
disposing the second organic patterns at odd numbered columns of the second pixel regions; and
disposing the third organic patterns at even numbered columns of the second pixel regions.

17. The method of claim 14, wherein forming the second and third organic patterns comprises disposing the second and third organic patterns at second pixel regions such that each second pixel region having the second organic patterns alternates with each second pixel region having the third organic patterns along both the row and column directions of the second pixel regions.

18. The method of claim 13, further including forming dummy organic patterns at a non-display region that surrounds a display region having the first, second and third regions simultaneously with forming the first, second, third, and fourth organic patterns.

19. An apparatus for manufacturing a display device, comprising:
a discharging unit including a first discharging head having a plurality of discharging nozzles, and a second discharging head having a plurality of discharging nozzles, the first discharging head and the second discharging head being substantially parallel to each other, a portion of the first discharging head being adjacent to a portion of the second discharging head;
an organic material providing unit configured to provide the discharging unit with organic material; and
a transferring unit configured to transfer the discharging unit in a first direction.

20. The apparatus of claim 19, wherein the first and second discharging heads are slanted with respect to the first direction.

21. The apparatus of claim 20, wherein an interval between each nozzle of the first and second discharging heads is substantially constant.

22. The apparatus of claim 19, wherein the organic material providing unit provides the discharging unit with one of material for a hole-injection material and material for an emitting material layer.

23. A method for manufacturing a display device, comprising:
disposing a plurality of nozzles along a length of a first discharging head, such that each nozzle is disposed apart from each adjacent nozzle at a constant interval;
disposing a plurality of nozzles along a length of a second discharging head, such that each nozzle is disposed apart from each adjacent nozzle at a constant interval;
disposing the first and second discharging heads at a transferring unit;
transferring the first and second discharging heads in a first direction with respect to a substrate;
forming a first organic pattern at a first region of the substrate and forming a second organic pattern at selected portions of a second region of the substrate using the first discharging head;
forming a third organic pattern at remaining portions of the second region and forming a fourth organic pattern at a third region of the substrate using the second discharging head.

24. The method of claim 23, wherein disposing the first and second discharging heads at the transferring unit comprises:
extending the first discharging head over the first and second regions of the substrate; and
extending the second discharging head over the second and third regions of the substrate.

25. The method of claim 24, further comprising disposing the first and second discharging heads substantially parallel to each other, such that a portion of each of the first and second discharging heads extending over the second region of the substrate are adjacent to each other.

26. The method of claim 25, further comprising disposing the first and second discharging heads at the transferring unit at an angle with respect to the first direction.

27. The method of claim 23, wherein forming the first, second, third and fourth organic patterns comprises:
providing an organic material to the first and second discharging heads via a organic material providing unit; and
discharging the organic material on the substrate.
